(19) United States
(12) Patent Application Publication
(10) Pub. No.: US 2024/0263083 A1
(43) Pub. Date: Aug. 8, 2024

(54) A SYSTEM AND A METHOD FOR STORING BIOLOGICAL FEEDSTOCK

(71) Applicant: Neste Oyj, Espoo (FI)

(72) Inventors: Jarmo HALTTUNEN, Espoo (FI); Fred VAN VUGT, Espoo (FI); Floris EBELI, Espoo (FI); Raymond VAN DER GRAAF, Espoo (FI); Ville MYKRÄ, Espoo (FI)

(73) Assignee: Neste Oyj, Espoo (FI)

(21) Appl. No.: 18/566,169

(22) PCT Filed: Jun. 2, 2022
(86) PCT No.: PCT/FI2022/050375

§ 371 Date: Dec. 1, 2023

(30) Foreign Application Priority Data
Jun. 3, 2021 (FI) 20215649

(51) Int. Cl. C10G 3/00; C02F 1/00; C02F 1/40; C02F 11/121; C02F 11/18; C02F 103/22; C02F 103/32

(52) U.S. Cl. CPC C10G 3/50; C02F 1/40; C02F 11/121; C02F 11/18; C02F 2001/007; C02F 2103/22; C02F 2103/322; C02F 2209/02; C10G 2300/1014; C10G 2300/1018

(57) ABSTRACT

A system for storing biological feedstock includes receiving tanks, storage tanks, and at least one slop tank. The biological feedstock is supplied to the receiving tanks from sources external to the system. Fat separated from the biological feedstock is transferred from the receiving tanks to the storage tanks, and sludge deposited on a bottom portion of each receiving tank and on a bottom portion of each storage tank is transferred to the slop tank. Fat separated from the sludge is transferred from the slop tank to the receiving tanks. Biological material is blended from biological feedstocks. The tanks act in different roles to improve the removal of sludge, and increases the yield of desired biological material.

### FIELD OF THE DISCLOSURE

The disclosure relates generally to handling of biological material containing biological feedstock, such as low-quality animal fat or plant oil, for renewable hydrocarbon production. More particularly, the disclosure relates to a method and a system for storing biological feedstock. Furthermore, the disclosure relates to a method and a system for producing renewable hydrocarbons.

### BACKGROUND

Oil refining into hydrocarbons suitable for fuel and chemical applications, for example diesel or aviation fuel, from renewable biological material is becoming more and more important for the fuel industry. The biological material may comprise various different types and grades of fats and oils, or residues and wastes thereof. Typically, suitable biological material for biological feedstock is acquired from several different sources, stored, transported to a production site, and purified before feeding into oil refining facilities for production of hydrocarbons. In many cases, biological feedstock is stored at ambient temperature for varying time periods before use. The storage time may extend from just a few days to several months, depending on the quality and quantity of the biological material available.

The above-mentioned biological feedstock is typically stored in a tank farm that may comprise separate tanks for biological feedstocks of different qualities. Depending on the availability and delivery timing of the biological material to the tank farm there may be several tanks with varying feedstock quality and tanks with varying amounts of impurities and water content. Tanks farms of the kind described above are however not free from challenges. One of the challenges is related to a need for removing sludge as well as solid impurities from the biological feedstock. If the sludge and solid impurities are not removed efficiently enough, it is challenging to achieve a sufficiently high or desired quality mixture of biological feedstocks for subsequent processing. Therefore, the delivery quality of the feedstock to the refinery may vary and may be time dependent, and cause fluctuations in the further processing and process adjustments. Moreover, the need to store the feedstock material in a tank for a longer period may induce gas formation problems due to microbial activity in aqueous conditions originating from activity of the microbes already residing inside the tank or transported thereto together with the feedstock material.

### SUMMARY

The following presents a simplified summary in order to provide a basic understanding of some embodiments of the invention. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a straight or curved geometric line, a geometric plane, a non-planar geometric surface, a geometric space, or any other geometric entity that is zero, one, two, or three dimensional.

In accordance with the invention, there is provided a new method for storing biological feedstock that may comprise various types and grades of animal fats and oils, plant fats and oils, or fish fats and oils, or wastes and residues thereof. In this document the word “fat” is used to also cover fatty materials which are pumpable with commercially available pumps in e.g. room temperature. A method according to the invention comprises:
supplying biological material containing biological feedstock to one or more receiving tanks,
transferring, from the one or more receiving tanks to one or more storage tanks, biological feedstock separated from the biological material,
transferring, from the one or more receiving tanks to one or more slop tanks, sludge deposited on a bottom portion of each receiving tank,
transferring, from the one or more slop tanks to the one or more receiving tanks, biological feedstock separated from the sludge, and
transferring, from the one or more storage tanks to the one or more slop tanks, sludge deposited on a bottom portion of each storage tank.

Biological feedstock for subsequent processing at an oil refinery can be blended from different biological feedstocks contained by different storage tanks. The above-described method where the tanks act in different roles improves the removal of sludge as well as other impurities and increases the yield of biological feedstock having the desired quality.

In accordance with the invention, there is further provided a new method for producing renewable hydrocarbons, the method comprising:
receiving biological material containing biological feedstock,
carrying out a method according to the invention for storing the biological feedstock, and subsequently
producing the renewable hydrocarbon from the biological feedstock.

The producing of the renewable hydrocarbon may comprise for example hydrotreatment processes, such as hydrodeoxygenation and isomerisation.

In accordance with the invention, there is further provided a new system for storing biological feedstock. A system according to the invention comprises:
one or more receiving tanks configured to receive biological material containing biological feedstock from a source external to the system, one or more storage tanks, and one or more slop tanks,
a first material transfer system configured to transfer, from the one or more receiving tanks to the one or more storage tanks, biological feedstock separated from the biological material,
a second material transfer system configured to transfer, from the one or more receiving tanks to the one or more slop tanks, sludge deposited on a bottom portion of each receiving tank,
a third material transfer system configured to transfer, from the one or more slop tanks to the one or more receiving tanks, biological feedstock separated from the sludge, and
a fourth material transfer system configured to transfer, from the one or more storage tanks to the one or more slop tanks, sludge deposited on a bottom portion of each storage tank.

In accordance with the invention, there is provided also a new system for producing renewable hydrocarbons, the system comprising:
a storage system being a system according to the invention for receiving biological material and for storing biological feedstock contained by the biological material,
a delivery system configured to remove the biological feedstock from the storage system, and
an oil refinery configured to receive the biological feedstock from the delivery system and to produce the renewable hydrocarbons from the biological feedstock.

The oil refinery may comprise for example at least one hydrotreatment reactor configured to carry out hydrodeoxygenation and/or isomerisation.

Exemplifying and non-limiting embodiments of the invention are described in accompanied dependent claims.

A desired mixture, i.e. a recipe, of different biological feedstocks for subsequent processing can be blended from biological feedstocks contained by different ones of the tanks. Especially, selecting suitable combinations of feedstock from the different storage tanks into final tanks will enable providing more uniform quality feedstock to the refinery, in terms of e.g. impurities and carbon number distribution.

Correspondingly, selecting suitable combinations of feedstock from the different receiving tanks into the storage tanks will enable providing different blends being stored in the storage system.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does as such not exclude a plurality.

### BRIEF DESCRIPTION OF THE FIGURES

Exemplifying and non-limiting embodiments of the invention and their advantages are explained in greater details below in the sense of examples and with reference to the accompanying drawings, in which:

FIG. 1 illustrates a system according to an exemplifying and non-limiting embodiment for storing biological feedstock,

FIG. 2 illustrates a part of a system according to an exemplifying and non-limiting embodiment for storing biological feedstock,

FIG. 3 illustrates a part of a system according to an exemplifying and non-limiting embodiment for storing biological feedstock,

FIG. 4 illustrates a system for producing renewable hydrocarbons, and

FIG. 5 shows a flowchart of a method according to an exemplifying and non-limiting embodiment for storing biological feedstock.

### DESCRIPTION OF EXEMPLIFYING EMBODIMENTS

The specific examples provided in the description below should not be construed as limiting the scope and/or the applicability of the accompanied claims. Lists and groups of examples provided in the description are not exhaustive unless otherwise explicitly stated.

Biological material as used herein refers to material collected from various sources and of varying quality. When using waste and residue materials the biological material may, in addition to components that can be used as biological feedstock, further include a wide variety of materials not suitable, or typically harmful, for further processing, such as water, metal impurities, microbes, pieces of bone, fur, hair, plastic flakes, pieces of rubber gloves, polyethylene, gelatins and proteins, chlorine components, salts, and the like.

The biological material suitable for further processing may comprise crude, refined or waste qualities of plant and/or vegetable oils and/or microbial oils may include babassu oil, carinata oil, soybean oil, canola oil, coconut oil, rapeseed oil, crude tall oil “CTO”, tall oil “TO”, tall oil fatty acid “TOFA”, tall oil pitch “TOP”, palm oil “PO”, palm oil fatty acid distillate “PFAD”, technical corn oil (TCO), jatropha oil, palm kernel oil, sunflower oil, castor oil, camelina oil, archaeal oil, bacterial oil, fungal oil, protozoal oil, algal oil, seaweed oil, oils from halophiles, and mixtures of any two or more thereof. Animal fats and/or oils may include crude, refined or waste qualities of inedible tallow, edible tallow, technical tallow, flotation tallow, lard, poultry fat, poultry oils, fish fat, fish oils, and mixtures of any two or more thereof. Greases may include yellow grease, brown grease, waste vegetable oils, restaurant greases, trap grease from municipalities such as water treatment facilities, and spent oils from industrial packaged food operations, and mixtures of any two or more thereof. These oils and/or fats typically comprise C10-C24 fatty acids and derivatives thereof, including esters of fatty acids, glycerides, i.e. glycerol esters of fatty acids. The glycerides may specifically include monoglycerides, diglycerides and triglycerides.

The biological feedstock or renewable feedstock as used herein refers to feedstock derived from the biological material. The sources for renewable feedstock are numerous including oils and/or fats, usually containing lipids e.g. fatty acids or glycerides, such as plant oil/fats, vegetable oil/fats, animal oil/fats, algae oil/fats, fish oil/fats, or oil/fats from other microbial processes, for example, genetically manipulated algae oil/fats, genetically manipulated oil/fats from other microbial processes and also genetically manipulated vegetable oil/fats. Components of these materials may also be used, for example, alkyl esters, typically C1-C5 alkyl esters, such as methyl, ethyl, propyl, iso-propyl, butyl, sec-butyl esters, or olefins. Additionally, the renewable feedstock may include C1-C5 alkyl alcohols, particularly methyl, ethyl, propyl, iso-propyl, butyl, and/or sec-butyl esters of fatty acids, and any combinations thereof.

The biological feedstock may additionally include free fatty acids, fatty acid esters including mono-, di-, and triglycerides, or combinations thereof. The biological feedstock is typically pretreated before entering it into the refining process for removal of several different impurities and to meet the processing specifications in terms of e.g. phosphorus, total metals and sodium, potassium, magnesium, calcium, iron, and copper impurities. Typical pretreatment methods include e.g. degumming, bleaching and deodorising.

In one embodiment, the biological feedstock include waste and residue material originating from animal fat/oil, such as animal fat “AF”, plant fat/oil such as palm oil and derivatives thereof, such as palm effluent sludge “PES”, and used cooking oil “UCO”. PES may be collected from the wastewater ponds of the palm mills. PES typically has a high portion of free fatty acids “FFA”, ˜50 . . . 80%, and for this reason a high amount of impurities like metals in the form of divalent/trivalent soaps. Because of its origin the PES feedstock material usually contains several types of microbes that can produce unwanted gases like methane. AF may contain a wide variety of impurities like solids, e.g. pieces of bone, fur, hair, plastic flakes, pieces of rubber gloves. There can also be metals and other impurities bonded to the fat molecules. Other impurities may comprise polyethylene that is dissolved to the fat, gelatins and proteins. Depending on the rendering method used for producing animal fats it may also contain microbes that can produce unwanted gases like methane, carbon monoxide and hydrogen. The slaughterhouse waste of animal origin containing animal fat, such as lard or tallow, is typically dry or wet rendered, preceding the storage in a storage tank. The fat always further contains inherent water or moisture mixed or bound into the fat. Thus, there will be some hydrolysis of triglycerides gradually taking place in a storage tank, together with a slow separation of water from the tissue or fat. This separation may take from a few days to several months, such as from 3 days to even 6 months. UCO may contain solid impurities like proteins, crumbs and other pieces of the food that has been cooked with the oil. There may further be excess amounts of chlorine in the form of salt or organic chlorine compounds.

The ¹⁴C-isotope content can be used as evidence of the renewable or biological origin of a feedstock, raw material or product. Carbon atoms of renewable material comprise a higher number of unstable radiocarbon ¹⁴C atoms compared to carbon atoms of fossil origin. Therefore, it is possible to distinguish between carbon compounds derived from biological sources, and carbon compounds derived from fossil sources by analysing the ratio of ¹²C and ¹⁴C isotopes. Thus, a particular ratio of said isotopes can be used to identify renewable carbon compounds and differentiate those from non-renewable i.e. fossil carbon compounds. The isotope ratio does not change in the course of chemical reactions. Example of a suitable method for analysing the content of carbon from biological sources is ASTM D6866 2020. An example of how to apply ASTM D6866 to determine the renewable content in fuels is provided in the article of Dijs et al., Radiocarbon, 48(3), 2006, pp 315-323. For the purpose of the present invention, a carbon-containing material, such as raw material, feedstock or product, is considered to be of renewable origin if it contains 90% or more modern carbon “pMC”, such as about 100% modern carbon, as measured using ASTM D6866.

Processing of renewable hydrocarbons suitable for use as renewable fuels or renewable chemicals from biological feedstock involves refining of the biological feedstock at an oil refinery. Typically, pretreatment of the crude biological feedstock is needed to meet the purity requirements for the oil refining process. The processing includes preferably hydrotreatment of the purified biological feedstock into hydrocarbons using catalytic processes. Preferably, catalytic hydrodeoxygenation combined with catalytic isomerisation, such as hydroisomerisation, is applied. The oxygen removal and branching of the hydrocarbons may be performed simultaneously or in sequence, and may further include other processing steps, such as hydrocracking for carbon chain length reduction or hydrofinishing for removal of remaining impurities.

By the term “tank” is meant herein an industrial scale container, such as a vertical cylindrical container, the size of which is typically from 300 m³ to 15000 m³. A tank farm may comprise several of these tanks, such as from 5 to 50. By the term “sludge” is meant herein material which contains a mixture of fat/oil and water, and from which the fat/oil and the water separates and settles with time. Moreover, the sludge typically contains small amounts of solid material, such as solid particles e.g. sand, phosphates, bones, and the like; and plastics. This sludge may comprise a high percentage, such as about 50%, of usable fat/oil.

By the term “hydrotreatment” is meant herein a catalytic processing of organic material by all means of molecular hydrogen. Preferably, hydrotreatment removes oxygen from organic oxygen containing compounds as water i.e. by hydrodeoxygenation “HDO”. Additionally or alternatively hydrotreatment may remove sulphur from organic sulphur containing compounds as hydrogen sulphide H2S, i.e. by hydrodesulphurisation “HDS”, it may further remove nitrogen from organic nitrogen containing compounds as ammonia NH3, i.e. by hydrodenitrofication “HDN”, and/or it may remove halogens, for example chlorine, from organic chloride containing compounds as hydrochloric acid HCl, i.e. by hydrodechlorination “HDCl”. It may further remove aromatic compounds by hydrodearomatisation “HDA”.

The term “hydrodeoxygenation” “HDO” means herein hydrodeoxygenation of feedstock of biological origin, such as feedstock comprising triglycerides or other fatty acid derivatives or fatty acids. It is the removal of carboxyl oxygen as water by means of molecular hydrogen under the influence of a catalyst. The hydrodeoxygenation may be accompanied by hydrodesulphurisation, hydrodenitrification, and/or hydrodechlorination reactions.

The term “isomerisation” means herein a reaction that causes branching of hydrocarbon chains of hydrotreated feedstock. Branching of hydrocarbon chains improves e.g. cold properties i.e. the isomerized hydrocarbons have better cold properties compared to merely hydrotreated feedstock. Better cold properties refer to e.g. a lower temperature value of a pour point or cloud point. The formed isoparaffins (also referred to as i-paraffins) may have one or more side chains, or branches, typically methyl or ethyl groups.

Typically, hydrodeoxygenation and isomerisation, such as hydroisomerisation, reactions take place in the presence of a catalyst suitable for the reaction. Reaction conditions and catalysts typically used in the hydrodeoxygenation of biological feedstock and in the isomerisation of resultant n-paraffins are disclosed in several documents. Examples of such processes are presented in e.g. FI100248, examples 1-3, and in WO2007003709. Advantageously, the hydrodeoxygenation may be performed at 200-400° C., 20-150 bar, using a supported Pd, Pt, Ni, NiMo, CoMo or NiW catalyst, the support being alumina, zeolite, silica, or mixtures thereof. The hydroisomeration may advantageously be performed at 200-500° C., 2-15 MPa, in the presence of a metal from the Element Group VIII further containing SAPO-11 or SAPO-41 or ZSM-22 or ZSM-23 or ferrierite, and Pt or Pd or Ni, and alumina or silica.

The oils and/or fats of biological origin may include a single kind of oil, a single kind of fat, mixtures of different oils, mixtures of different fats, mixtures of oil(s) and fat(s), fatty acids, glycerol, and/or mixtures of the above-mentioned. Typically, when waste and residue material are used, they already comprise mixtures of several components.

Before the biological feedstock is entering the pretreatment processes of the oil refinery, it is typically stored in storage tanks at a tank farm which may or may not be in the vicinity of the actual oil refinery. The biological material may be transported to the tank farm area from several different locations all over the world using all suitable methods for transportation, typically by trucks, railway carriages, or marine vessels. The tank farm comprises usually several storage tanks whereto the biological feedstock material is transported from feedstock vendors and wherefrom the biological feedstock is transported to the oil refinery.

Water behaves very differently with biological lipid materials than with fossil oil and fossil waste oil. For example, water is dissolved into biological lipid materials, i.e. resides as bound water inside biological lipid material and gradually forms free water by separating from the biological lipid material. This is not the case with fossil oil, wherefrom free water can be easily separated. Therefore, for example, a continuous separation approach where fossil oil is allowed to flow out from an upper surface of liquid containing the fossil oil and water is not appropriately applicable in a system for handling biological lipid materials because the water is slowly and gradually separating from biological lipid materials.

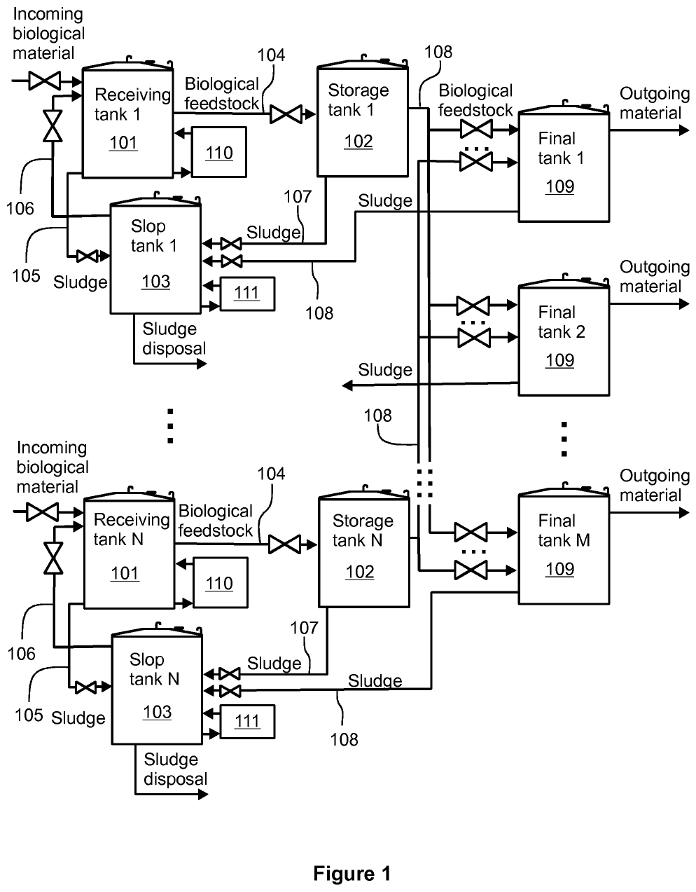

FIG. 1 illustrates a system according to an exemplifying and non-limiting embodiment for storing biological feedstock that may comprise various types and grades of animal fats and oils, plant fats and oils, or fish fats and oils, or wastes and residues thereof. The system is a tank farm that comprises receiving tanks 101 configured to receive biological material containing biological feedstock from a source external to the system. The volume of each receiving tank can be for example from 300 m³ to 15000 m³. The biological material can be unloaded from trucks, railway carriages, and/or some other transportation devices from which the biological material is loaded to the receiving tanks 101. The system further comprises storage tanks 102 and slop tanks 103. The volume of each storage tank can be for example from 300 m³ to 15000 m³. The exemplifying system illustrated in FIG. 1 comprises many receiving tanks, many storage tanks, and many slop tanks. It is also possible that a system according to an exemplifying embodiment comprises only one receiving tank, only one storage tank, and only one slop tank.

The system comprises a first material transfer system 104 configured to transfer, from the receiving tanks 101 to the storage tanks 102, the biological feedstock separated from the biological material. The maximum transfer rate i.e. the peak transfer rate of the first material transfer system 104 from each receiving tank can be for example from 5 m³/s to 500 m³/s, e.g. from 5 m³/s to 300 m³/s. The biological feedstock can be separated from the biological material for example so that the biological material is allowed to settle in the receiving tanks to allow the biological feedstock, sludge, and aqueous phase to separate from each other at least partially. The sludge deposited on a bottom portion of each receiving tank is sludge containing water. The separation is however not perfect and thus the first material transfer system 104 transfers not only the separated biological feedstock but also somewhat the sludge and the aqueous phase. The system comprises a second material transfer system 105 configured to transfer, from the receiving tanks 101 to the slop tanks 103, sludge deposited on a bottom portion of each receiving tank. As the above-mentioned separation is not perfect, the second material transfer system 105 transfers also somewhat the biological feedstock as well as the aqueous phase to the slop tanks 103. The system comprises a third material transfer system 106 configured to transfer, from the slop tanks 103 to the receiving tanks 101, biological feedstock separated from the sludge in the slop tanks 103. The system comprises a fourth material transfer system 107 configured to transfer, from the storage tanks 102 to the one or more slop tanks, sludge deposited on a bottom portion of each storage tank. The sludge deposited on a bottom portion of each storage tank is sludge containing water. The biological feedstock is advantageously stored longer in the storage tanks 102 than in the receiving tanks 101. The above-described system where the tanks act in different roles improves the removal of sludge and water as well as other impurities and increases the yield of biological feedstock having desired quality.

In a system according to an exemplifying and non-limiting embodiment, the first material transfer 104 system is configured to transfer, from two or more of the receiving tanks 101 to one of the storage tanks 102, different qualities of the biological feedstock to make a blend of the different qualities of the biological feedstock into each storage tank under consideration.

A system according to an exemplifying and non-limiting embodiment further comprises final tanks 109 and a fifth material transfer system 108 configured to transfer the biological feedstock from the storage tanks 102 to the final tanks 109. The volume of each final tank can be for example from 300 m³ to 15000 m³. The maximum transfer rate i.e. the peak transfer rate of the fifth material transfer system 108 from each storage tank can be for example from 5 m³/s to 500 m³/s, e.g. from 5 m³/s to 300 m³/s. Furthermore, the fifth material transfer system 108 is optionally configured to transfer, from the final tanks 109 to the slop tanks 103, sludge deposited on a bottom portion of each final tank. However, at this point the amount of separated water and sludge is typically minor compared to the receiving and storage tanks. The sludge deposited on a bottom portion of each final tank is sludge containing water. The exemplifying system illustrated in FIG. 1 comprises many final tanks, but it is also possible that a system according to an exemplifying embodiment comprises only one final tank. In a system according to an exemplifying and non-limiting embodiment, the fifth material transfer 108 system is configured to transfer, from two or more of the storage tanks 102 to one of the final tanks 109, different qualities of the biological feedstock to make a blend of the different qualities of the biological feedstock. The fifth material transfer 108 may comprise for example valves or mass transfer adjusting or controlling equipment and/or other means with the aid of which it can be selected from which ones of the storage tanks 102 the biological feedstock is supplied to the final tank under consideration and in which quantities. Thus, the composition of the blend formed at the final tank(s) can be controlled.

As mentioned above, the receiving tanks 101 usually contain an aqueous phase typically originating from the biological material supplied to the receiving tanks 101. Water is typically separated from the biological material over time and accumulated into the lower parts of the receiving tanks 101 and thereby the aqueous phase is formed. Correspondingly, the upper parts of the receiving tanks 101 contain fatty and/or oily phases i.e. the biological feedstock. Free water contained in the aqueous phase enables growth of microorganisms, such as bacteria, generating unwanted gas at anaerobic conditions. The formed gas is carried into the upper part of the receiving tanks, and the formed gas may be flammable, explosive, poisonous, and/or corrosive, and thereby prone to cause safety problems. The formed gas may comprise, for example, hydrogen H₂, methane CH₄, carbon monoxide CO and/or other unwanted gaseous substances.

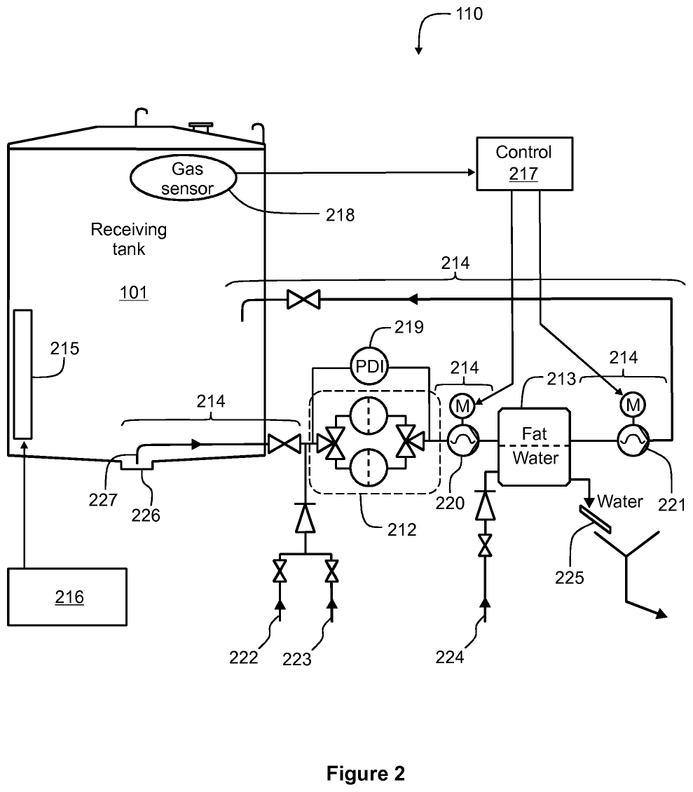

In a system according to an exemplifying and non-limiting embodiment, at least one of the receiving tanks 101 is provided with an aqueous phase removal system 110 configured to at least partially remove the aqueous phase from the receiving tank under consideration to reduce the above-described unwanted gas formation inside the receiving tank. The aqueous phase removal system 110 is illustrated in FIG. 2 and described in more details in FI20215646.

The aqueous phase removal system 110 comprises a filtering system 212 that can be provided with a pressure difference indicator “PDI” 219 for indicating the condition of the filtering system 212, e.g. dirt deposit and blockages in the filtering system 212. The filtering system 212 may comprise for example one or more sieve filters and/or some other suitable filters. The aqueous phase removal system 110 comprises a water separator 213 that can be for example like ACO Grease separator Lipator-S-RA or Evac EcoTrap grease separator or some other suitable water separator device. In the aqueous phase removal system 110 illustrated in FIG. 2, the water outlet of the water separator 213 is provided with a spout 225 which enables visual inspection of water separation. In this exemplifying case, the water separator 213 comprises an inlet 224 for supplying fresh water to keep the water separator 213 in a proper operating status.

The aqueous phase removal system 110 comprises a material transport system 214 that is configured to remove, from the lower part and more preferably from the bottom part of the receiving tank 101, a portion comprising part of the above-mentioned aqueous phase, part of the above-mentioned biological feedstock, and part of the above-mentioned sludge. In this exemplifying case, the bottom of the receiving tank 101 comprises a recession 226 and the material transport system 214 comprises a pipe 227 extending to the recession 226 from above and configured to remove the above-mentioned portion from the recession 226. The material transport system 214 is configured to transfer the above-mentioned portion through the filtering system 212 that separates at least part of the sludge from the portion. The material transport system 214 is configured to transfer the filtered portion from the filtering system 212 to the water separator 213 configured to separate at least part of the aqueous phase from the filtered portion. The material transport system 214 is configured to transfer, from the water separator 213 back to the receiving tank 101, residual of the filtered portion from which the aqueous phase has been at least partially removed. The above-described functionality removes free water from the receiving tank 101 and preferably also at least part of the microorganisms residing in the aqueous phase, and thereby growth and activity of bacteria and/or other microbes that generate unwanted gas e.g. hydrogen is inhibited. As a corollary, unwanted gas formation inside the receiving tank 101 is reduced and thereby the safety of the receiving tank system is improved.

In the exemplifying aqueous phase removal system 110 illustrated in FIG. 2, the material transport system 214 comprises a first pump 220 between the filtering system 212 and the water separator 213. The first pump 220 is configured to transfer the portion from the receiving tank 101 through the filtering system 212 to the water separator 213. The material transport system 214 comprises a second pump 221 between the water separator 213 and the receiving tank 101. The second pump 221 is configured to transfer the residual of the filtered portion from the water separator 213 to the receiving tank 101. Each of the first pump 220 and the second pump 221 can be for example a screw pump, a centrifugal pump, progressive cavity pump, or some other suitable pump. In this exemplifying case, the material transport system 214 comprises an inlet 222 for pressurized air for pipe cleaning and an inlet 223 for feeding water to the material transport system 214. The pressurized air and/or water can be used for e.g. preventing and removing unwanted material deposits from surfaces of the material transport system 214.

The exemplifying aqueous phase removal system 110 illustrated in FIG. 2 comprises a control system 217 configured to activate the material transport system 214 to transfer the above-mentioned portion through the filtering system 212 to the water separator 213 in accordance with a predetermined timing schedule. The predetermined timing schedule can be for example such that the pumps 220 and 221 are started a predetermined number of times per day, e.g. 3 times per day, for a predetermined running period e.g. 10 minutes or some other suitable time period after each start. The running period can be determined for example empirically with tests. It is also possible that the pumps 220 and 221 are controlled manually. It is also possible that the control system 217 is configured to run the pumps 220 and 221 automatically according to a predetermined timing schedule, and the control system 217 comprises a user interface which allows manual control of the pumps 220 and 221, too. The control system 217 may comprise one or more processor circuits, each of which can be a programmable processor circuit provided with appropriate software, a dedicated hardware processor for example an application specific integrated circuit “ASIC”, or a configurable hardware processor for example a field programmable gate array “FPGA”. The control system 217 may comprise one or more memory circuits each of which can be e.g. a random access memory circuit “RAM”.

The exemplifying aqueous phase removal system 110 illustrated in FIG. 2 comprises a gas sensor 218 configured to measure concentration of one or more of the unwanted gases, e.g. hydrogen H₂, methane CH₄, and/or carbon monoxide CO, contained by the gas space of the receiving tank 101. Furthermore, the aqueous phase removal system 110 comprises an alarm system configured to output an alarm signal in response to a situation in which one or more measured concentrations of one or more unwanted gases exceed its limit value. The alarm signal can be for example an acoustic signal, a light signal, and/or a data signal transmitted via a data transfer network to a receiver device, e.g. a mobile phone, of a worker and/or to a control and monitoring room. Advantageously, the control system 217 runs the pumps 220 and 221 in accordance with a predetermined timing schedule and, in addition, the alarm system is operating and the pumps 220 and 221 are manually controllable, too.

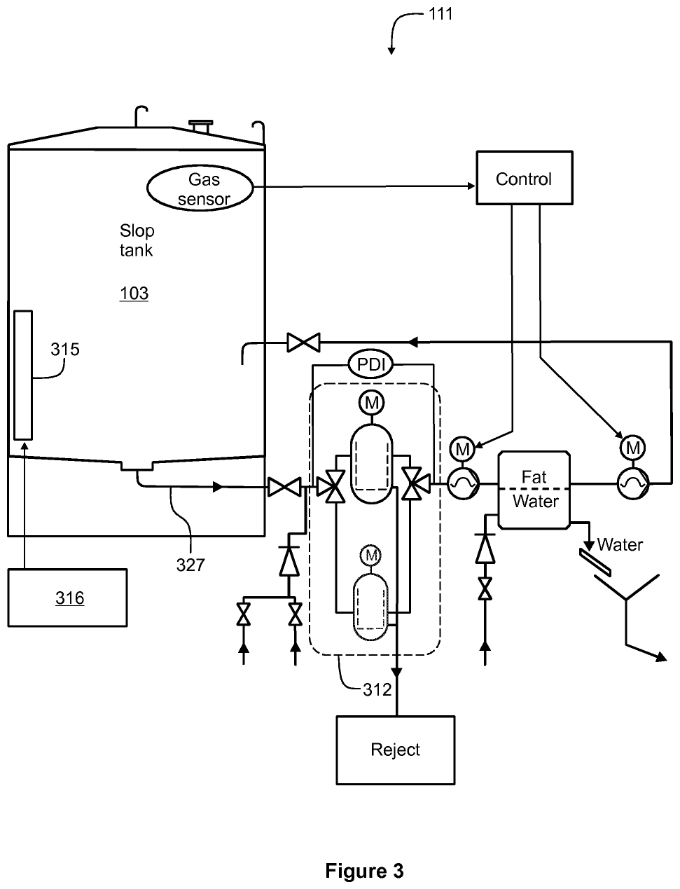

Like the receiving tanks 101, also the slop tanks 103 may contain an aqueous phase and thereby formation of unwanted gases of the kind described above may take place in the slop tanks 103. In a system according to an exemplifying and non-limiting embodiment, at least one of the slop tanks 103 is provided with an aqueous phase removal system 111 configured to remove the aqueous phase at least partially from the slop tank under consideration to reduce the above-described unwanted gas formation inside the slop tank. The aqueous phase removal system 111 is illustrated in FIG. 3 and described in more details in FI20215646. The aqueous phase removal system 111 is otherwise like the aqueous phase removal system 110 illustrated in FIG. 2, but the filtering system 312 comprises pressure screens which have a self-cleaning property and the pipe 327 extends to the recession of the bottom of the slop tank 103 from below.

A system according to an exemplifying and non-limiting embodiment comprises heaters configured to warm up the biological material contained by the receiving tanks 101 and the biological material contained by the storage tanks 102. The system according to this exemplifying embodiment comprises temperature controllers configured to control the temperature of the biological material to be between 50° C. and 95° C., more preferably between 53° C. and 90° C., and yet more preferably between 55° C. and 80° C. Two of the heaters are denoted with references 215 and 315 in FIGS. 2 and 3, and two of the temperature controllers are denoted with references 216 and 316 in FIGS. 2 and 3. Each heater may comprise for example heater tubes located inside the respective receiving or storage tank and configured to conduct gaseous or liquid heating fluid. A system according to an exemplifying and non-limiting embodiment comprises heaters configured to warm up the biological material contained by the final tanks 109 and/or the biological material contained by the slop tanks 103. The system according to this exemplifying embodiment comprises temperature controllers configured to control the temperature of the biological material contained by the final tanks 109 and/or the slop tanks 103 to be between 50° C. and 95° C., more preferably between 53° C. and 90° C., and yet more preferably between 55° C. and 80° C.

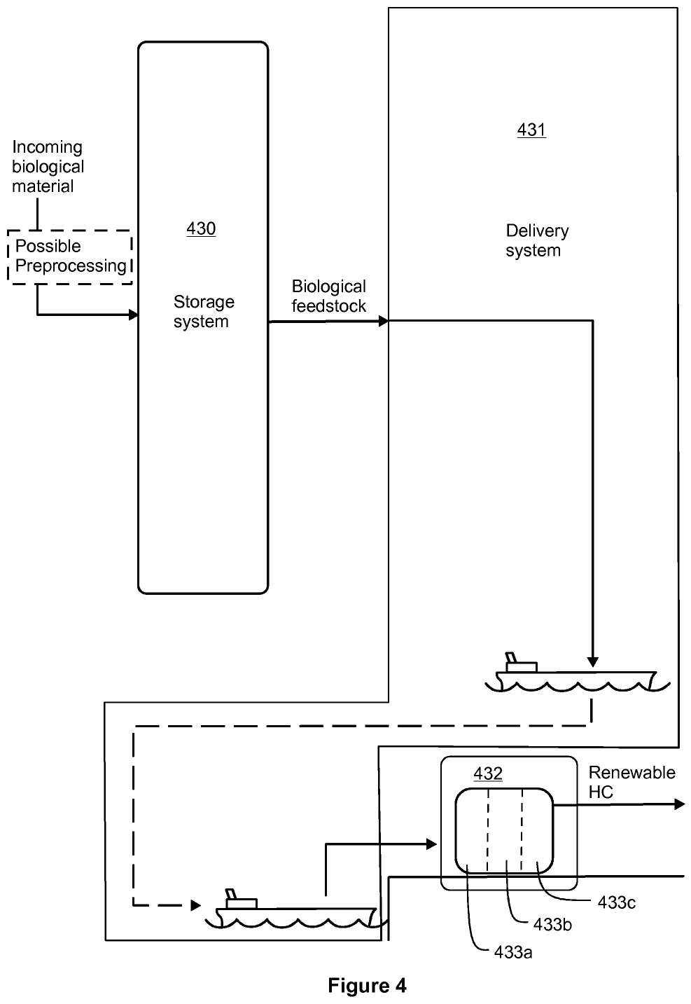

FIG. 4 illustrates a system according to an exemplifying and non-limiting embodiment for producing renewable hydrocarbons “HC” from biological feedstock. The system comprises a storage system 430 that is configured to receive biological material and to store biological feedstock contained by the biological material. The storage system 430 can be for example like the system described above and illustrated in FIG. 1. The storage system 430 may comprise for example means for unloading the biological material from trucks, railway carriages, and/or some other transportation devices and for loading the biological feedstock to one or more receiving tanks of the storage system 430.

The system illustrated in FIG. 4 comprises an oil refinery 432 configured to produce the renewable hydrocarbons from the biological feedstock. The oil refinery 432 may comprise for example at least one pretreatment zone 433a, at least one hydrotreatment zone 433b configured to carry out hydrodeoxygenation, and at least one isomerisation zone 433c configured to carry out branching of the hydrocarbons produced at the hydrodeoxygenation zone 433b.

The system comprises a delivery system 431 configured to deliver the biological feedstock from the storage system 430 to the oil refinery 432. The delivery system 431 comprises means for unloading the biological feedstock from the one or more storage tanks and/or final tanks of the storage system 430 and for delivering the biological feedstock to the oil refinery 432. In this exemplifying case, the delivery system 431 comprises a ship connection between the storage system 430 and the oil refinery 432. In a simple case, the delivery system 431 may be just a pipeline, for example, if the storage system 431 is in the vicinity of the refinery. The delivery system 431 may further comprise processing means for handling the biological feedstock prior to the ship connection, e.g. for purifying the biological feedstock and/or for producing desired feedstock blends.

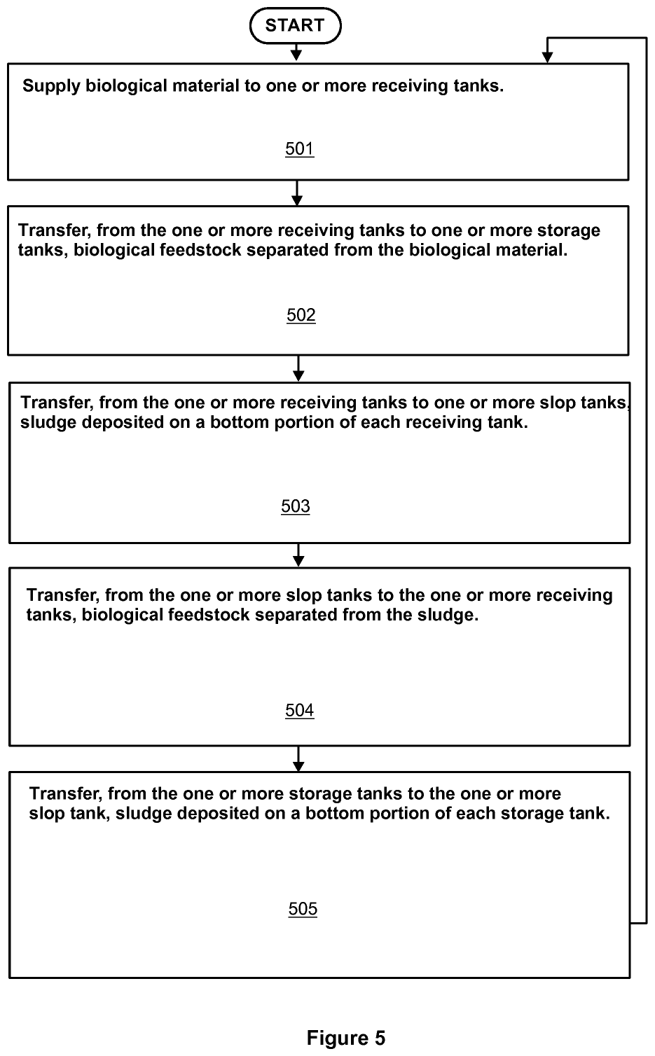

FIG. 5 shows a flowchart of a method according to an exemplifying and non-limiting embodiment for storing biological feedstock suitable for use in renewable hydrocarbon production. The method comprises the following actions:
action 501: supplying biological material containing the biological feedstock to one or more receiving tanks,
action 502: transferring, from the one or more receiving tanks to one or more storage tanks, the biological feedstock separated from the biological material,
action 503: transferring, from the one or more receiving tanks to one or more slop tanks, sludge containing water and deposited on a bottom portion of each receiving tank,
action 504: transferring, from the one or more slop tanks to the one or more receiving tanks, biological feedstock separated from the sludge, and
action 505: transferring, from the one or more storage tanks to the one or more slop tanks, sludge containing water and deposited on a bottom portion of each storage tank.

The separation of the sludge in the one or more receiving tanks is not perfect and thus the action 502 transfers not only the separated biological feedstock to the one or more storage tanks but also somewhat sludge. To compensate for this, the action 505 transfers, from the one or more storage tanks to the one or more slop tanks, sludge deposited on the bottom portion of each storage tank.

In a method according to an exemplifying and non-limiting embodiment, the biological feedstock comprises at least one of the following: animal fat, used cooking oil, palm effluent sludge.

A method according to an exemplifying and non-limiting embodiment comprises transferring, from two or more of the receiving tanks to one or more of the storage tanks, different qualities of the biological feedstock to make a blend of the different qualities of the biological feedstock into each storage tanks under consideration. The blending may cause reactions in which sludge that contains water is formed. Thus, it is advantageous that the sludge is removed not only from the receiving tanks but from the storage tanks, too.

A method according to an exemplifying and non-limiting embodiment comprises transferring, from the one or more storage tanks to one or more final tanks, the biological feedstock and transferring, from the one or more final tanks to the one or more slop tanks, sludge containing water and deposited on a bottom portion of each final tank.

The separation of the sludge in the one or more receiving tanks and in the one or more storage tanks is not necessarily perfect and thus not only the biological feedstock is transferred to the one or more final tanks, but also somewhat sludge can be transferred to the one or more final tanks. To compensate for this, sludge deposited on the bottom portion of each final tank is transferred to the one or more slop tanks.

A method according to an exemplifying and non-limiting embodiment comprises transferring, from two or more of the storage tanks to one of the final tanks, different qualities of the biological feedstock to make a blend of the different qualities of the biological feedstock. The blending may cause reactions in which sludge that contains water is formed. Thus, it is advantageous that the sludge is removed not only from the receiving tanks and from the storage tanks but from the final tanks, too.

A method according to an exemplifying and non-limiting embodiment comprises at least partially removing aqueous phase from at least one of the receiving tanks to reduce unwanted gas formation inside the receiving tank under consideration in which at least one microorganism produces unwanted gas in presence of the aqueous phase. In a method according to an exemplifying and non-limiting embodiment, the at least partially removing the aqueous phase comprises:
transferring a portion comprising part of the aqueous phase, part of sludge contained by the receiving tank, and part of the biological feedstock from a bottom part of the receiving tank to a filtering system separating at least part of the sludge from the portion,
transferring the filtered portion from the filtering system to a water separator,
separating, with the water separator, at least part of the aqueous phase from the filtered portion, and
transferring, from the water separator back to the receiving tank, residual of the filtered portion from which the aqueous phase has been at least partially removed.

A method according to an exemplifying and non-limiting embodiment comprises at least partially removing aqueous phase from at least one of the slop tanks to reduce unwanted gas formation inside the slop tank under consideration in which at least one microorganism produces unwanted gas in presence of the aqueous phase. In a method according to an exemplifying and non-limiting embodiment, the at least partially removing the aqueous phase comprises:
transferring a portion comprising part of the aqueous phase, part of sludge contained by the slop tank, and part of the biological feedstock from a bottom part of the slop tank to a filtering system separating at least part of the sludge from the portion,
transferring the filtered portion from the filtering system to a water separator,
separating, with the water separator, at least part of the aqueous phase from the filtered portion, and
transferring, from the water separator back to the slop tank, residual of the filtered portion from which the aqueous phase has been at least partially removed.

A method according to an exemplifying and non-limiting embodiment comprises warming up the biological feedstock contained by the one or more receiving tanks and by the one or more storage tanks and controlling temperature of the biological feedstock to be between 50° C. and 95° C., more preferably between 53° C. and 90° C., and yet more preferably between 55° C. and 80° C.

A method according to an exemplifying and non-limiting embodiment comprises allowing the biological material to settle in the one or more receiving tanks to allow the biological feedstock, sludge, and aqueous phase to separate from each other at least partially.

In a method according to an exemplifying and non-limiting embodiment, the biological feedstock is stored longer in the one or more storage tanks than in the one or more receiving tanks.

In a method according to an exemplifying and non-limiting embodiment, different qualities of the biological material are supplied to different ones of the receiving tanks and different qualities of the biological feedstock are stored in different ones of the storage tanks.

A method according to an exemplifying and non-limiting embodiment for producing, from biological feedstock, renewable hydrocarbons suitable for use as renewable fuel or renewable chemical or components thereto comprises:
receiving biological material containing the biological feedstock,
carrying out a method according to an embodiment of the invention for storing the biological feedstock, and subsequently
producing the renewable hydrocarbon from the biological feedstock.

The production of the renewable hydrocarbon may comprise for example pretreatment and hydrodeoxygenation of the biological feedstock, and branching of hydrocarbons produced by the hydrodeoxygenation.

The specific examples provided in the description given above should not be construed as limiting. Therefore, the invention is not limited merely to the exemplifying and non-limiting embodiments described above. Lists and groups of examples provided in the description are not exhaustive unless otherwise explicitly stated.

In the method of the present invention, sludge containing water and deposited on a bottom portion of each receiving tank, or storage tank or even final tank, still contains an oily phase or fat suitable for use as feedstock, possibly even to an extent of 60 vol-% of the total amount of the sludge. This portion may be recovered and recycled by transferring and collecting the sludge into a slop tank and settling it, whereafter the oily phase may be returned back to the receiving or storage tanks and reused as feedstock. As the dimensions of the tanks are several hundreds of cubic meters, the amount of recovered oily phase per year may add up to tens of tons.

1-22. (canceled)

23. A method for storing biological feedstock suitable for use in renewable hydrocarbon production, the method comprising:
supplying biological material containing the biological feedstock to one or more receiving tanks;
transferring, from the one or more receiving tanks to one or more storage tanks, the biological feedstock separated from the biological material;
transferring, from the one or more receiving tanks to one or more slop tanks, sludge deposited on a bottom portion of each receiving tank,
transferring, from the one or more slop tanks to the one or more receiving tanks, biological feedstock separated from the sludge; and
transferring, from the one or more storage tanks to the one or more slop tanks, sludge deposited on a bottom portion of each storage tank.

24. A method according to claim 23, wherein the biological feedstock comprises:
at least one of animal fat, used cooking oil, and/or palm effluent sludge.

25. A method according to claim 23, comprising:
transferring, from the one or more storage tanks to one or more final tanks, the biological feedstock; and
transferring, from the one or more final tanks to the one or more slop tanks, sludge deposited on a bottom portion of each final tank.

26. A method according to claim 25, comprising:
transferring, from two or more of the storage tanks to one of the one or more final tanks, different qualities of the biological feedstock to make a blend of the different qualities of the biological feedstock.

27. A method according to claim 23, comprising:
at least partially removing an aqueous phase from at least one of the one or more receiving tanks to reduce unwanted gas formation inside the receiving tank under consideration in which at least one microorganism produces unwanted gas in presence of the aqueous phase.

28. A method according to claim 27, wherein the at least partially removing the aqueous phase contained by the receiving tank comprises:
transferring a portion containing part of the aqueous phase, part of sludge contained by the receiving tank, and part of the biological feedstock from a bottom part of the receiving tank to a filtering system separating at least part of the sludge from the portion to form a filtered portion;
transferring the filtered portion from the filtering system to a water separator;
separating, with the water separator, at least part of the aqueous phase from the filtered portion; and
transferring, from the water separator back to the receiving tank, a residual of the filtered portion from which the aqueous phase has been at least partially removed.

29. A method according to claim 27, comprising:
at least partially removing the aqueous phase from at least one of the one or more slop tanks to reduce unwanted gas formation inside the slop tank under consideration in which at least one microorganism produces unwanted gas in presence of the aqueous phase.

30. A method according to claim 29, wherein the at least partially removing the aqueous phase contained by the slop tank comprises:
transferring a portion containing part of the aqueous phase, part of sludge contained by the slop tank, and part of the biological feedstock from a bottom part of the slop tank to a filtering system separating at least part of the sludge from the portion to form a filtered portion;
transferring the filtered portion from the filtering system to a water separator;
separating, with the water separator, at least part of the aqueous phase from the filtered portion; and
transferring, from the water separator back to the slop tank, a residual of the filtered portion from which the aqueous phase has been at least partially removed.

31. A method according to claim 23, comprising:
warming up the biological feedstock contained by the one or more receiving tanks and by the one or more storage tanks; and
controlling temperature of the biological feedstock to be between 50° C. and 95° C.

32. A method according to claim 23, comprising:
allowing the biological material to settle in the one or more receiving tanks to allow the biological feedstock, sludge, and an aqueous phase to at least partially separate from each other.

33. A method according to claim 23, comprising:
storing biological feedstock longer in the one or more storage tanks than in the one or more receiving tanks.

34. A method according to claim 23, comprising:
supplying different qualities of the biological material to different ones of the receiving tanks; and
storing different qualities of the biological feedstock in different ones of the storage tanks.

35. A method for producing a renewable hydrocarbon, the method comprising:
receiving biological material containing biological feedstock;
storing the biological feedstock, and subsequently:
producing the renewable hydrocarbon from the biological feedstock, where the method for storing the biological feedstock includes:
supplying the biological material containing the biological feedstock to one or more receiving tanks;
transferring, from the one or more receiving tanks to one or more storage tanks, the biological feedstock separated from the biological material;
transferring, from the one or more receiving tanks to one or more slop tanks, sludge deposited on a bottom portion of each receiving tank;
transferring, from the one or more slop tanks to the one or more receiving tanks, biological feedstock separated from the sludge; and
transferring, from the one or more storage tanks to the one or more slop tanks, sludge deposited on a bottom portion of each storage tank.

36. A method according to claim 35, wherein the producing the renewable hydrocarbon comprises:
pretreatment and hydrodeoxygenation of the biological feedstock; and
branching of hydrocarbons produced by the hydrodeoxygenation.

37. A system for storing biological feedstock, the system comprising:
one or more receiving tanks configured to receive biological material containing the biological feedstock from a source external to the system, one or more storage tanks, and one or more slop tanks;
a first material transfer system configured to transfer, from the one or more receiving tanks to the one or more storage tanks, the biological feedstock separated from the biological material;
a second material transfer system configured to transfer, from the one or more receiving tanks to the one or more slop tanks, sludge deposited on a bottom portion of each receiving tank;
a third material transfer system configured to transfer, from the one or more slop tanks to the one or more receiving tanks, biological feedstock separated from the sludge; and
a fourth material transfer system configured to transfer, from the one or more storage tanks to the one or more slop tanks, sludge deposited on a bottom portion of each storage tank.

38. A system according to claim 37, comprising:
one or more final tanks; and
a fifth material transfer system configured to transfer, from the one or more storage tanks to the one or more final tanks, the biological feedstock and to transfer, from the one or more final tanks to the one or more slop tanks, sludge deposited on a bottom portion of each final tank.

39. A system according to claim 38, wherein the fifth material transfer system is configured to transfer, from two or more of the storage tanks to one of the one or more final tanks, different qualities of the biological feedstock to make a blend of the different qualities of the biological feedstock.

40. A system according to claim 37, wherein at least one of the one or more receiving tanks is provided with an aqueous phase removal system comprising:
a filtering system;
a water separator; and
a material transport system configured to:
transfer a portion containing part of an aqueous phase, part of a sludge contained by the receiving tank, and part of the biological feedstock from a bottom part of the receiving tank to the filtering system configured to separate at least part of the sludge from the portion to form a filtered portion;
transfer the filtered portion from the filtering system to the water separator configured to separate at least part of an aqueous phase from the filtered portion; and
transfer, from the water separator back to the receiving tank, a residual of the filtered portion from which the aqueous phase has been at least partially removed.

41. A system according to claim 37, wherein at least one of the one or more slop tanks is provided with an aqueous phase removal system comprising:
a filtering system;
a water separator; and
a material transport system configured to:
transfer a portion containing part of the aqueous phase, part of the sludge contained by the slop tank, and part of the biological feedstock from a bottom part of the slop tank to the filtering system configured to separate at least part of the sludge from the portion;
transfer the filtered portion from the filtering system to the water separator configured to separate at least part of the aqueous phase from the filtered portion; and
transfer, from the water separator back to the slop tank, residual of the filtered portion from which the aqueous phase has been at least partially removed.

42. A system according to claim 37, comprising:
heaters configured to warm up the biological material contained by the one or more receiving tanks and by the one or more storage tanks; and
temperature controllers configured to control temperature of the biological material to be between 50° C. and 95° C.

43. A system for producing renewable hydrocarbons, the system comprising:
a storage system configured to receive biological material and to store biological feedstock contained by the biological material;
a delivery system configured to remove the biological feedstock from the storage system; and
an oil refinery configured to receive the biological feedstock from the delivery system and to produce the renewable hydrocarbons from the biological feedstock, wherein the storage system includes:
one or more receiving tanks configured to receive the biological material containing the biological feedstock from a source external to the storage system, one or more storage tanks, and one or more slop tanks;
a first material transfer system configured to transfer, from the one or more receiving tanks to the one or more storage tanks, the biological feedstock separated from the biological material;
a second material transfer system configured to transfer, from the one or more receiving tanks to the one or more slop tanks, sludge deposited on a bottom portion of each receiving tank;
a third material transfer system configured to transfer, from the one or more slop tanks to the one or more receiving tanks, biological feedstock separated from the sludge; and
a fourth material transfer system configured to transfer, from the one or more storage tanks to the one or more slop tanks, sludge deposited on a bottom portion of each storage tank.

44. A system according to claim 43, wherein the oil refinery comprises:
at least one pretreatment zone;
at least one hydrotreatment zone configured to carry out hydrodeoxygenation; and
at least one isomerisation zone configured to carry out branching of the hydrocarbons produced at the hydrodeoxygenation zone.
